(19) United States
(12) Patent Application Publication
(10) Pub. No.: US 2011/0033258 A1
(43) Pub. Date: Feb. 10, 2011

(54) LOAD SECUREMENT APPARATUS, SYSTEM, AND METHOD

(75) Inventor: Curt C. Unander, Orland Park, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: ILLINOIS TOOL WORKS INC., Glenview, IL (US)

(21) Appl. No.: 12/824,615

(22) Filed: Jun. 28, 2010

Related U.S. Application Data
(60) Provisional application No. 61/221,335, filed on Jun. 29, 2009.

(51) Int. Cl. B60P 7/135; B61D 45/00

(52) U.S. Cl. 410/154; 410/121; 206/386

(57) ABSTRACT

The load securement apparatus, system, and method includes a pallet onto which freight can be loaded and a shroud for surrounding the freight on the pallet. The system and method can also include a drop down void filler for filling space wherein the drop down void filler can be positioned along a longitudinal plane of the transportation vehicle between two pallets loaded with freight. Panels, such as, for example, honeycomb panels, can be positioned both along a transverse plane of the transportation vehicle as well as a longitudinal plane of the transportation vehicle. Bulkhead panels can also be positioned along a transverse plane of the transportation vehicle between two pallets loaded with freight and can fill space and further secure the freight. Additionally, an airbag can be positioned along a transverse plane of the transportation vehicle between two bulkhead panels and can also fill space and secure the freight.

### CROSS REFERENCE TO RELATED APPLICATION

This application claims priority to earlier filed U.S. Provisional Application No. 61/221,335, filed on Jun. 29, 2009, the disclosure of which is hereby incorporated by reference, in its entirety.

### FIELD OF THE INVENTION

The present invention generally relates to shipping freight. More particularly, the present invention pertains to an apparatus, system, and method for securing freight during shipping.

### BACKGROUND OF THE INVENTION

Railcars, trucks, trailers and other vehicles, have been used for centuries to transport freight quickly and efficiently over long distances. For example, shipment by railcar allows for large amount of freight to be shipped with a lower impact on the environment, because of its high energy efficiency.

When freight is loaded into a railcar, it is often secured by a bulkhead panel or other device which limits the movement of the freight within the railcar. However, these bulkhead panels do not necessarily provide adequate protection for more delicate freight such as juice packets and produce.

Accordingly, it is desirable to provide a load securement system and method that is capable of overcoming the disadvantages described herein at least to some extent.

### SUMMARY OF THE INVENTION

The foregoing needs are met, to a great extent, by the present invention, wherein in some embodiments a load securement apparatus, system, and method that is capable of overcoming the disadvantages described herein at least to some extent is provided.

A first embodiment of the present invention relates to an apparatus for securing freight loaded onto pallets for shipment in a transportation vehicle. The apparatus includes a shroud, which can be made from corrugated cardboard, corrugated plastic, or any other strong, lightweight material that absorbs impact.

A second embodiment of the present invention relates to a system for securing freight loaded onto pallets for shipment in a transportation vehicle. The system can include a pallet onto which the freight can be loaded, the pallet defining an open space enveloping its perimeter defined by an outer surface of the freight loaded onto the pallet. The system can also include one or more shrouds having walls formed from corrugated cardboard, corrugated plastic or any other strong, lightweight material that absorbs impact. The shrouds can define an interior space disposed over at least one pallet, wherein the interior space accommodates the freight loaded onto said pallet and the walls have a thickness to fill the open space on the pallet. Additional, load securement devices can be included in the system, such as a drop down void filler for filling space along a longitudinal plane of the transportation vehicle wherein the drop down void filler can be positioned between two pallets loaded with freight.

Further, a third embodiment of the invention can be a system which can include the features of the first two embodiments. The third embodiment can also include a first arrangement of panels, such as, for example, honeycomb panels, for filling space and securing freight wherein the panel can be positioned along a longitudinal plane of the transportation vehicle between two pallets loaded with freight, a second arrangement of panels, such as for example, honeycomb panels, for filling space and securing the freight wherein such panels can be positioned along a longitudinal plane of the transportation vehicle between a pallet loaded with freight and a wall of the transportation vehicle, and a third arrangement of panels, such as, for example, honeycomb panels, for filling space and securing the freight wherein such panels are positioned along a transverse plane of the transportation vehicle between two pallets loaded with freight. The system can also include bulkhead panels for filling space and securing freight wherein the bulkhead panel can be positioned along a transverse plane of the transportation vehicle between two pallets loaded with freight and an airbag for filling space and securing the freight wherein the airbag can be positioned along a transverse plane of the transportation vehicle between bulkhead panels.

In accordance with another aspect of the invention, in a system for securing a plurality of freight items for shipment in a transportation vehicle on one or more pallets onto which the freight can be loaded, each pallet defines an open space enveloping a perimeter defined by an outer surface of the freight items loaded onto each pallet. The system includes at least one shroud having walls defining an interior space disposed over at least one pallet, wherein the interior space accommodates one or more of the plurality of freight items loaded onto said pallet and the walls have a thickness to fill the open space. Each of the walls of the shroud can include a flap extending from a top edge of the wall of the shroud such that the flap can be folded down to cover the top of the freight loaded onto the pallet.

In accordance with another aspect of the invention, the shroud can be made from corrugated cardboard or corrugated plastic. The shroud can also include a lap joint which is secured prior to the shroud being placed around the freight items loaded onto the pallet. The system can further include at least one drop down void filler for filling space and securing the freight items. The drop down void filler is positioned along a longitudinal plane of the transportation vehicle between two pallets loaded with freight. Additionally, the system can include a first arrangement of panels for filling space and securing the freight wherein each of said first arrangement of said panels is positioned along longitudinal planes of the transportation vehicle between two pallets loaded with freight. The system can also include a second arrangement of panels for filling space and securing the freight. Each of said second arrangement of said panels is positioned along longitudinal planes of the transportation vehicle between a pallet loaded with freight and a wall of the transportation vehicle. The system can include a third arrangement of honeycomb panels for filling space and securing the freight. Each of the third arrangement of said panels is positioned along transverse planes of the transportation vehicle between two pallets loaded with freight. The system can also include bulkhead panels for filling space and securing the freight wherein the bulkhead panels are positioned along transverse planes of the transportation vehicle between two pallets loaded with freight. The system can also include an airbag for filling space and securing the freight wherein the airbag is positioned along a transverse plane of the transportation vehicle between bulkhead panels.

In accordance with another aspect of the invention a system for securing a plurality of freight items for shipment in a transportation vehicle can include one or more pallets onto which the freight can be loaded, each pallet defining an open space enveloping around a perimeter defined by an outer surface of the freight items loaded onto each pallet. The system can also include at least one shroud, each having at least four walls defining an interior space disposed over at least one pallet, wherein the interior space accommodates one or more of the freight items loaded onto said pallet and the walls have a thickness to fill the open space and the shroud is wrapped around the plurality of freight items loaded on the pallet. Additionally the shroud can define a lap joint which allows a first wall and a fourth wall of the shroud to be connected to form the interior space of the shroud. The first wall and the fourth wall can also be connected after the shroud is wrapped around the freight items loaded on the pallet.

In accordance with another aspect of the invention, the system can further include at least one drop down void filler for filling space and securing the freight items wherein the drop down void filler is positioned along a longitudinal plane of the transportation vehicle between two pallets loaded with freight. Additionally, the system can include a first arrangement of panels for filling space and securing the freight wherein each of said first arrangement of said panels is positioned along longitudinal planes of the transportation vehicle between two pallets loaded with freight. The system can also include a second arrangement of panels for filling space and securing the freight wherein each of said second arrangement of said panels is positioned along longitudinal planes of the transportation vehicle between a pallet loaded with freight and a wall of the transportation vehicle. The system can include a third arrangement of honeycomb panels for filling space and securing the freight wherein each of the third arrangement of said panels is positioned along transverse planes of the transportation vehicle between two pallets loaded with freight. The system can also include bulkhead panels for filling space and securing the freight wherein the bulkhead panels are positioned along transverse planes of the transportation vehicle between two pallets loaded with freight. The system can also include an airbag for filling space and securing the freight wherein the airbag is positioned along a transverse plane of the transportation vehicle between bulkhead panels.

There has thus been outlined, rather broadly, certain embodiments of the invention in order that the detailed description thereof, herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a partially sectional view of a load securement apparatus, system, and method in accordance with one or more embodiments of the invention.

FIG. 2 is an exploded view of a shroud in accordance with an embodiment of the invention.

FIG. 3 is a view of the drop down void filler in accordance with an embodiment of the invention.

FIG. 4 is a view of a shroud in accordance with an embodiment of the invention.

FIG. 5 is an alternate view of a shroud in accordance with an embodiment of the invention.

### DETAILED DESCRIPTION

The present invention provides, in some embodiments, a load securement apparatus, system, and method for securing freight during shipping. The load securement apparatus, system, and method includes a pallet onto which freight can be loaded and a shroud for surrounding the freight on the pallet. The system and method can also include a drop down void filler for filling space wherein the drop down void filler is positioned along a longitudinal plane of the transportation vehicle between two pallets loaded with freight. Panels, such as, for example, honeycomb panels, can be positioned both along transverse planes of the transportation vehicle as well as longitudinal planes of the transportation vehicle. Bulkhead panels positioned along transverse planes of the transportation vehicle between two pallets loaded with freight can also fill space and further secure the freight. Additionally, an airbag positioned along a transverse plane of the transportation vehicle between two bulkhead panels can also fill space.

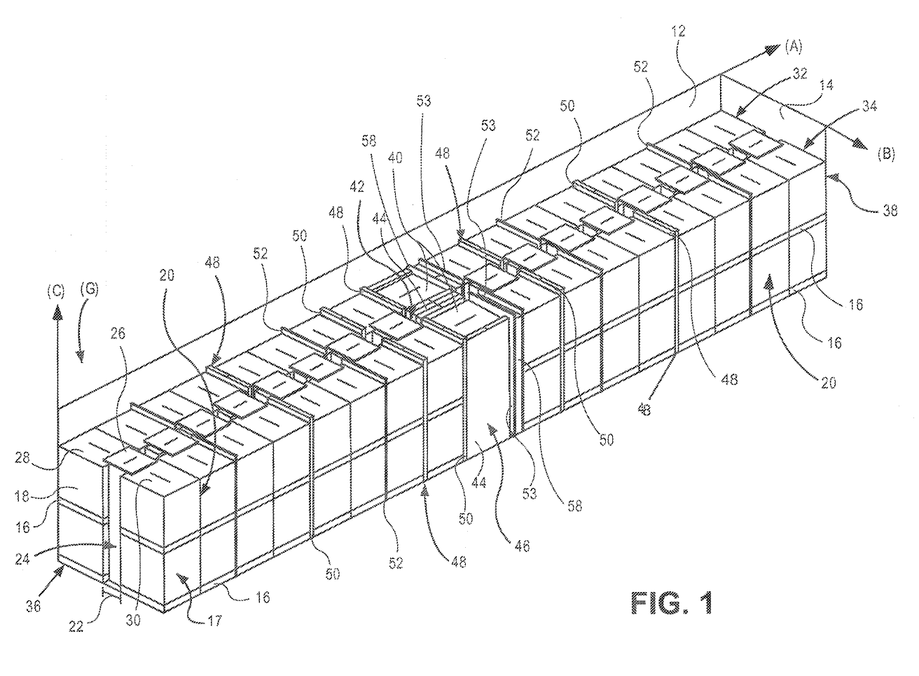

The invention will now be described with reference to the drawing figures, in which like reference numerals refer to like parts throughout. FIG. 1 is a partially sectional view of a load securement apparatus, system, and method in accordance with one or more embodiments of the invention.

FIG. 1 shows a loaded transportation vehicle 10, such as a railcar, trailer, or truck, in accordance with an embodiment of the invention. Wall 12 of the transportation vehicle 10 defines a longitudinal axis (A) of the transportation vehicle. Wall 14 of the transportation vehicle defines a transverse axis (B) of the transportation vehicle. The transportation vehicle also has a normal axis (C), which is parallel to gravity vector (G).

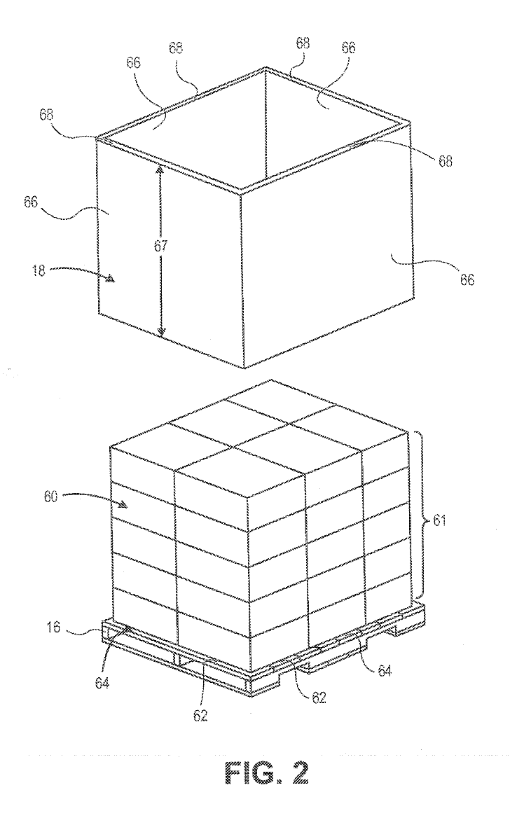

In a first aspect and a first embodiment of the invention, pallets 16 can be loaded with freight items and the freight can be surrounded with a shroud 18, which can be made from corrugated cardboard, corrugated plastic, or any other strong lightweight material that absorbs impact. The shroud 18 will be discussed in more detail with respect to FIG. 2 below. Pallets 16 loaded with the freight surrounded by the shroud 18, will be referred to as loaded pallets 17, and can be stacked two high as discrete stacks 20 along the normal axis (C) of the transportation vehicle 10. Stacks 20 of loaded pallets 17 then can be loaded into the transportation vehicle 10, in a configuration such as, two across along a transverse plane parallel with the transverse axis (B). The benefit of the shroud 18 is that it imparts vertical stacking strength to the freight items loaded onto the pallet 16, and provides cushioning and shock absorption between the freight and stacks loaded on the pallets.

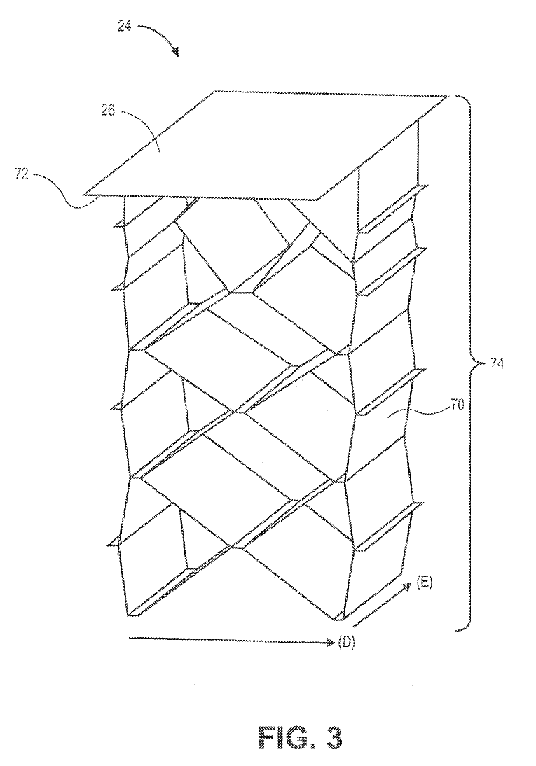

In another embodiment and yet another aspect of the invention, pallets 16 can be loaded with freight items and the freight can be surrounded with a shroud 18, and loaded into a transportation vehicle 10, as described with respect to the first embodiment. A space 22 can be left between the stacks 20 of loaded pallets 17 along a transverse plane of the transportation vehicle 10. In another embodiment of the invention, at least one drop down void filler 24, or another load securement structure suitable to fill space 22, can be positioned in the space 22 between the stacks 20 of loaded pallets 17. A top surface 26 of the drop down void filler 24 can be balanced on top surfaces 28, 30 of the two stacks 20 of loaded pallets 17 defining the space 22. The structure of the drop down void filler 24 will be discussed in more detail with respect to FIG. 3.

In another embodiment and yet another aspect of the invention, freight can be stacked and loaded into a transportation vehicle in a similar manner to the embodiments discussed above. Further, stacks 20 of loaded pallets 17 can be loaded into the transportation vehicle 10 and arranged in line along two longitudinal planes parallel with the longitudinal axis (A), so that there are two rows 32, 34 of stacks 20. For instance, as shown in FIG. 1, each row 32 and 34 can have seventeen stacks 20. Because transportation vehicle sizes may vary, different numbers of stacks may fit into the rows 32, 34, and the example showing two rows 32 and 34 of seventeen stacks 20 should not be considered limiting.

Further with respect to another embodiment of the invention, in order to fill excess space between the stacks 20 in the transportation vehicle 10 along both the longitudinal axis (A) and the transverse axis (B) and also brace the stacks 20 various bulkheads and brace components can be used. Drop down void fillers 24, or another load securement structure suitable to fill space 22, can be placed in the space 22 between the stacks 20 of loaded pallets 17. For instance, as shown in FIG. 1, sixteen drop down void fillers 24 can be positioned along a longitudinal plane parallel with the longitudinal axis of the transportation vehicle 10 starting at each of the opposite ends 36, 38 of the transportation vehicle 10. As the size of the transportation vehicle 10 can vary the number of drop down void fillers 24 shown in this example should not be considered limiting.

The middle pair 40 of stacks 20, which can have an orientation rotated 90 degrees about its normal axis relative to the orientation of other stacks 20, is not shown as having a drop down void filler 24 in the space 22 in between them. Instead, this middle pair 40 of stacks 20 can have a first arrangement 42 of panels 44, such as, for example honeycomb panels, positioned in the space 22 in between them. The first arrangement 42 of three panels 44 is positioned along a longitudinal plane of the transportation vehicle 10. In the example shown in FIG. 1, each of the panels 44 in the first arrangement 42 is 48-in wide by 108-in tall by 6-in deep. However, depending on the size of the transportation vehicle the number and dimensions of the panels 44 can vary. Generally, if a honeycomb panel is used it can be formed from two sheets of cardboard or other material with reinforcing blocks in between the two sheets of cardboard, or any other strong, lightweight material that absorbs impact. A second arrangement 46 of panels 44 can be positioned between the longitudinal outside walls 12 of the transportation vehicle 10 and a side of the stacks 20. The second arrangement 46 of panels 44 can also be positioned along a longitudinal plane of the transportation vehicle 10.

Further, with respect to another embodiment of the invention, as shown in FIG. 1, a third arrangement 48 of panels 50, such as for example, honeycomb panels, is positioned along each of five transverse planes of the transportation vehicle 10. The third arrangement 48 of panels 50 is such that a panel 50 can be positioned transversely between stacks 20 of loaded pallets 17 in each of rows 32 and 34, such that the panels 50 can be two across along a transverse plane of the transportation vehicle 10. For instance, as shown in FIG. 1, the third arrangement 48 of panels 50 is repeated between the fourth and fifth stacks 20 from the end 38 of the transportation vehicle 10, between the seventh and eighth stacks 20 from the end 38 of the transportation vehicle 10, between the ninth and tenth stacks 20 from the end 38 of the transportation vehicle 10, between the tenth and eleventh stacks 20 from the end 38 of the transportation vehicle 10, and between the thirteenth and fourteenth stacks 20 from the end 38 of the transportation vehicle 10. In the example shown in FIG. 1, panel 50 can be 48-in wide by 108-in tall by 4-in deep. However, depending on factors such as the dimensions of the transportation vehicle the number placement and dimensions of the panels 50 can vary.

Further with respect to another embodiment of the invention, bulkhead panels 52 can also be positioned along transverse planes of the transportation vehicle 10, as shown in FIG. 1. The bulkhead panels 52 can be positioned between stacks 20 of loaded pallets 17 in each of the rows 32 and 34, such that the bulkhead panels 52 are two stacks 20 across along a transverse plane of the transportation vehicle 10. In the example shown in FIG. 1, this arrangement of bulkhead panels 52 can be repeated four times throughout the transportation vehicle 10. As shown in FIG. 1, the arrangement of bulkhead panels 52 can be repeated between the second and third stacks 20 from the end 38 of the transportation vehicle 10, between the sixth and seventh stacks 20 from the end 38 of the transportation vehicle 10, between the eleventh and twelfth stacks 20 from the end 38 of the transportation vehicle 10, and between the fifteenth and sixteenth stacks 20 from the end 38 of the transportation vehicle 10. Bulkhead panels 53 can also be positioned between the eighth stack 20 from end 38 of the transportation vehicle 10 and the ninth stack 20 from the end 38 of the transportation vehicle 10 in each of rows 32 and 34. These bulkhead panels 53 can be positioned along transverse planes of the transportation vehicle 10. Two bulkhead panels 53 can be positioned in each of rows 32 and 34. However, depending on factors such as the dimensions of the transportation vehicle the number placement and dimensions of the bulkhead panels 52 can vary. Additionally, an airbag 58 can be positioned along a transverse plane between the two bulkhead panels 53 in each of rows 32 and 34. The bulkhead panels 52 and 53 are generally made from wood, but can be made from any other strong lightweight material. The airbag 58 can be made from a woven polyester material or from paper, vinyl or any other strong and durable material.

FIG. 2 illustrates a shroud 18 in accordance with an embodiment of the invention. FIG. 2 illustrates a pallet 16 having a plurality of freight items 60 loaded onto its top surface. When the freight 60 is loaded onto the pallet 16, the pallet defines an open space 62 around the outer perimeter of the stacked freight items 60 beyond the outer surface of the freight 60 loaded onto the pallet 16. The freight can be loaded onto the pallet 16 such that the depth 64 of the open space 62 on the pallet 16 is the same all around the perimeter of the freight 60. In order to fill the open space 62, such that the freight 60 cannot move on the pallet 16, a shroud 18 is placed around the freight 60, such that it fills the open space 62. The shroud 18 can have at least four walls 66 which surround the stacked freight items 60 loaded onto the pallet 16 on all sides. The height 67 of the shroud 18 can be equal to the height 61 of the freight 60 loaded on the pallet 16. The depth 68 of each of the side walls 66 is equal to the depth 64 open space 62. The shroud 18 can be made from corrugated cardboard, corrugated plastic, or any other strong, light material that absorbs impact. The shroud 18 can also have a top wall connecting all side walls 66. The shroud 18 provides vertical stacking strength for the freight 60 loaded onto the pallet 16 and can be used alone as an apparatus or method of securing and protecting freight in a transportation vehicle, or can be used in conjunction with a system of one or more other load securement devices including the various embodiments discussed herein.

FIG. 3 illustrates a drop down void filler 24 in accordance with an embodiment of the invention. The drop down void filler 24 can include a top surface 26. Top surface 26 can be balanced on top surfaces 28, 30 of the two stacks 20 of loaded pallets 17 defining the space 22, as illustrated in FIG. 1. Top surface 26 can be made from cardboard or any other lightweight yet strong material. A honeycomb 70 hangs down from a bottom surface 72 of the top surface 26. The honeycomb 70 can be formed from cardboard or any other lightweight yet strong material that can absorb impact. The drop down void filler 24 can have a length 74 equal to the height of the stack 20 of loaded pallets 17 or any other length appropriate for filling the space 22 between the stacks 20. The drop down void filler 24 can also have a longitudinal axis (D) and a transverse axis (E), such that when the drop down void filler 24 is positioned within a transportation vehicle 10, as shown in FIG. 1, the longitudinal axis (D) of the drop down void filler 24 is parallel to the longitudinal axis (A) of the transportation vehicle 10 and the transverse axis (E) of the drop down void filler 24 is parallel to the transverse axis (B) of the transportation vehicle 10. Drop down void fillers of other materials or forms can be used for the present invention, including, for example, injection-molded plastic void-filler, or other void fillers which accomplish the object of the void fillers discussed in relation to the invention discussed herein.

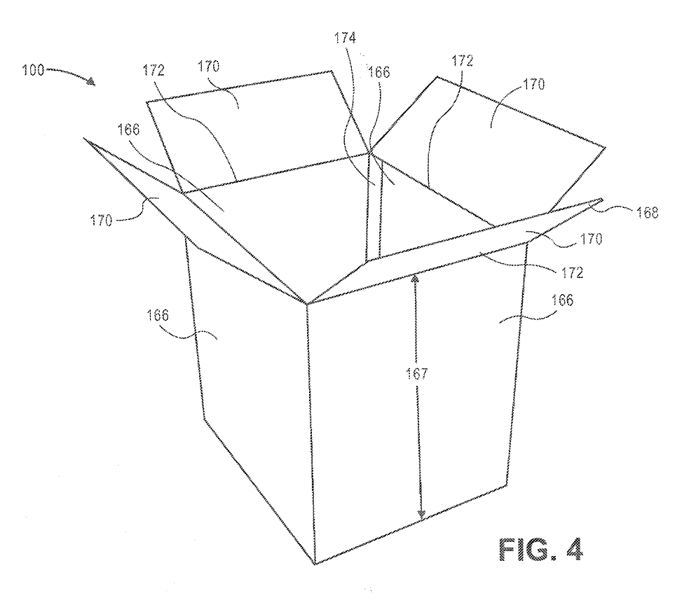

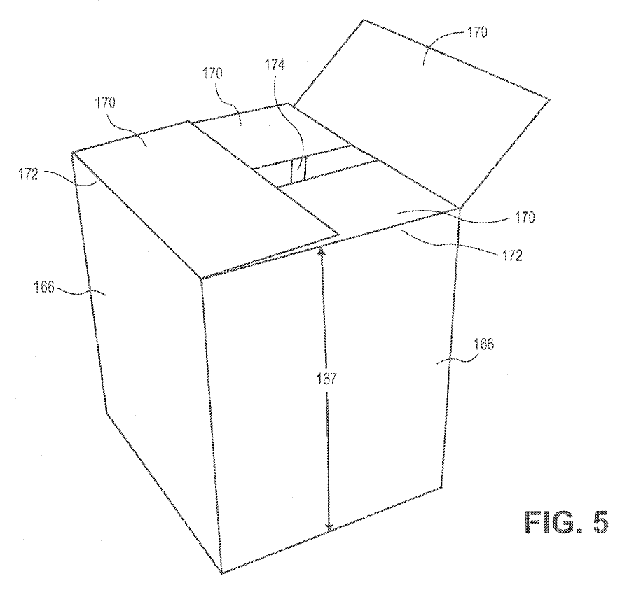

FIGS. 4 and 5 illustrate a shroud 100 in accordance with an embodiment of the invention. The shroud 100 can have at least four walls 166 which surround the stacked freight items loaded onto the pallet on all sides, not shown. The height 167 of the shroud 100 can be equal to the height of the freight loaded on the pallet. The depth 168 of each of the side walls 166 is equal to the depth of the open space surrounding the items of freight loaded onto the pallet. The shroud 100 can be made from corrugated cardboard, corrugated plastic, or any other strong, light material that absorbs impact. The shroud 100 can also have top flaps 170 extending from a top edge 172 of each of the walls 166 of the shroud. The flaps 170 can be folded down, as illustrated in FIG. 5, to cover the top surface of the freight loaded onto the pallet.

FIG. 4 also illustrates a lap joint 174. The lap joint 174 secures the first and fourth of the side walls 166 together. The lap joint 174 can be glued together prior to placing the shroud 100 over the freight loaded onto the pallets. Alternately, the lap joint 174 can be left unglued. The shroud 100 can then be wrapped around the freight loaded onto the pallet and the lap joint 174 secured. The lap joint 174 can be secured with glue, tape, shrink wrap, stretch film, or any other suitable packing securement material. Securing the lap joint 174 after the shroud 100 has been wrapped around the freight loaded onto the pallet allow only one worker to place the shroud 100 around the freight. The shroud 100 provides vertical stacking strength for the freight loaded onto the pallet and can be used alone as an apparatus or method of securing and protecting freight in a transportation vehicle, or can be used in conjunction with a system of one or more other load securement devices including the various embodiments discussed herein.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for securing a plurality of freight items for shipment in a transportation vehicle on one or more pallets onto which the freight can be loaded, each pallet defining an open space enveloping a perimeter defined by an outer surface of the freight items loaded onto each pallet comprising:
at least one shroud having walls defining an interior space disposed over at least one pallet, wherein the interior space accommodates one or more of the plurality of freight items loaded onto said pallet and the walls have a thickness to fill the open space; and,
wherein each of the walls of the shroud comprises a flap extending from a top edge of the wall of the shroud such that the flap can be folded down to cover the top of the freight loaded onto the pallet.

2. The system of claim 1 wherein the shroud comprises one of corrugated cardboard or corrugated plastic.

3. The system of claim 1 wherein the shroud comprises a lap joint which is secured prior to the shroud being placed around the freight items loaded onto the pallet.

4. The system of claim 1 further comprising at least one drop down void filler for filling space and securing the freight items, wherein the drop down void filler is positioned along a longitudinal plane of the transportation vehicle between two pallets loaded with freight.

5. The system of claim 1 further comprising a first arrangement of panels for filling space and securing the freight wherein each of said first arrangement of said panels is positioned along longitudinal planes of the transportation vehicle between two pallets loaded with freight.

6. The system of claim 1 further comprising a second arrangement of panels for filling space and securing the freight wherein each of said second arrangement of said panels is positioned along longitudinal planes of the transportation vehicle between a pallet loaded with freight and a wall of the transportation vehicle.

7. The system of claim 1 further comprising a third arrangement of honeycomb panels for filling space and securing the freight wherein each of the third arrangement of said panels is positioned along transverse planes of the transportation vehicle between two pallets loaded with freight.

8. The system of claim 1 further comprising bulkhead panels for filling space and securing the freight wherein the bulkhead panels are positioned along transverse planes of the transportation vehicle between two pallets loaded with freight.

9. The system of claim 1 further comprising an airbag for filling space and securing the freight wherein the airbag is positioned along a transverse plane of the transportation vehicle between bulkhead panels.

10. A system for securing a plurality of freight items for shipment in a transportation vehicle comprising:
one or more pallets onto which the freight can be loaded, each pallet defining an open space enveloping a perimeter defined by an outer surface of the freight items loaded onto each pallet;
at least one shroud each having at least four walls defining an interior space disposed over at least one pallet, wherein the interior space accommodates one or more of the plurality of freight items loaded onto said pallet and the walls have a thickness to fill the open space and the shroud is wrapped around the freight items loaded on the pallet;
the shroud defining a lap joint which allows a first wall and a fourth wall of the shroud to be connected to form the interior space of the shroud; and,
wherein the first wall and the fourth wall are connected after the shroud is wrapped around the freight items loaded on the pallet.

11. The system of claim 10 wherein the shroud comprises one of corrugated cardboard or corrugated plastic.

12. The system of claim 10 further comprising at least one drop down void filler for filling space and securing the freight items wherein the drop down void filler is positioned along a longitudinal plane of the transportation vehicle between two pallets loaded with freight.

13. The system of claim 10 further comprising a first arrangement of panels for filling space and securing the freight wherein each of said first arrangement of said panels is positioned along longitudinal planes of the transportation vehicle between two pallets loaded with freight.

14. The system of claim 10 further comprising a second arrangement of panels for filling space and securing the freight wherein each of said second arrangement of said panels is positioned along longitudinal planes of the transportation vehicle between a pallet loaded with freight and a wall of the transportation vehicle.

15. The system of claim 10 further comprising a third arrangement of honeycomb panels for filling space and securing the freight wherein each of the third arrangement of said panels is positioned along transverse planes of the transportation vehicle between two pallets loaded with freight.

16. The system of claim 10 further comprising bulkhead panels for filling space and securing the freight wherein the bulkhead panels are positioned along transverse planes of the transportation vehicle between two pallets loaded with freight.

17. The system of claim 10 further comprising an airbag for filling space and securing the freight wherein the airbag is positioned along a transverse plane of the transportation vehicle between bulkhead panels.

18. A system for securing a plurality of freight items loaded onto pallets for shipment in a transportation vehicle comprising:
one or more pallets onto which the freight can be loaded, each pallet defining an open space enveloping a perimeter defined by an outer surface of the freight items loaded onto each pallet;
at least one shroud having walls defining an interior space disposed over at least one pallet, wherein the interior space accommodates one or more of the plurality of freight items loaded onto said pallet and the walls have a thickness to fill the open space;
at least one drop down void filler for filling space and securing the freight items wherein the drop down void filler is positioned along a longitudinal plane of the transportation vehicle between two pallets loaded with freight;
a first arrangement of panels for filling space and securing the freight wherein each of said first arrangement of said panels is positioned along longitudinal planes of the transportation vehicle between two pallets loaded with freight;
a second arrangement of panels for filling space and securing the freight wherein each of said second arrangement of said panels is positioned along longitudinal planes of the transportation vehicle between a pallet loaded with freight and a wall of the transportation vehicle;
a third arrangement of honeycomb panels for filling space and securing the freight wherein each of the third arrangement of said panels is positioned along transverse planes of the transportation vehicle between two pallets loaded with freight;
bulkhead panels for filling space and securing the freight wherein the bulkhead panels are positioned along transverse planes of the transportation vehicle between two pallets loaded with freight; and
an airbag for filling space and securing the freight wherein the airbag is positioned along a transverse plane of the transportation vehicle between bulkhead panels.

19. The system of claim 18 wherein the shroud comprises one of corrugated cardboard or corrugated plastic.

20. The system of claim 18 wherein the shroud comprises a top wall connecting all of the walls defining the interior space.
